(19) United States
(12) Patent Application Publication
(10) Pub. No.: US 2024/0133111 A1
(43) Pub. Date: Apr. 25, 2024

(54) MICROPLASTIC FILTER FOR A WASHING MACHINE

(71) Applicant: Hengst SE, Münster (DE)

(72) Inventors: Andreas Stephan, Münster (DE); Henning Tillmanns, Münster (DE); Marcus Wegmann, Ostbevern (DE); Gunter Mathy, Münster (DE); Markus Lüersmann, Münster (DE); Tom Klaver, Köln (DE); Martin Heitjans, Rheine (DE)

(21) Appl. No.: 18/535,596

(22) Filed: Dec. 11, 2023

Related U.S. Application Data
(63) Continuation of application No. PCT/EP2022/065523, filed on Jun. 8, 2022.

(30) Foreign Application Priority Data
Jun. 14, 2021 (DE) 10 2021 115 442.1

(51) Int. Cl. D06F 39/10; B01D 29/35; B01D 29/54; B01D 29/58; B01D 29/64; B01D 29/82; B01D 35/153; B01D 35/30; C02F 1/00; D06F 39/08

(52) U.S. Cl. CPC D06F 39/10; B01D 29/35; B01D 29/54; B01D 29/58; B01D 29/6415; B01D 29/824; B01D 35/153; B01D 35/30; C02F 1/001; D06F 39/085; B01D 2201/301; B01D 2201/325; C02F 2103/002

(57) ABSTRACT

A microplastic filter (also referred herein as fluid filter) for a washing machine has a filter housing, a first filter screen, a second filter screen, an inlet opening 16, and an outlet opening. The inlet and outlet openings communicate with each other through the first filter screen to define a direction of fluid flow. The first filter chamber has a retentate outlet, is particularly easy to handle if the second filter screen is arranged in a cavity of the filter housing, the inlet and outlet openings communicate with each other through the second filter screen, and the retentate outlet is arranged on a side of the second filter screen that faces the fluid flow.

### RELATED ART

### 1. Field of the Invention

The invention relates to a fluid filter, for example a microplastic filter configured to remove microplastics from a fluid to be filtered (which is typically the wastewater from a washing machine for textiles). The fluid filter has a filter housing, a first filter screen, a second filter screen, an inlet opening, and an out- let opening. The filter housing forms a cavity. The fluid can flow into the cavity through an inlet opening of the housing and flow out of the cavity and thus out of the housing through an outlet opening. The first filter screen is arranged in the cavity and at least partially delimits at least a first filter chamber. The inlet and outlet are connected to each other, i.e. they are in fluid communication via the first filter screen. The first filter chamber also has a retentate outlet.

### 2. Description of Related Art

Microplastics are increasingly being detected in nature, where they do not degrade or do not degrade quickly enough and have a negative impact on fauna, especially in the oceans, because microplastics enter the food chain there. Microplastics are generally defined as plastic particles with dimensions of less than 5 mm. A contribution to microplastic pollution of water bodies is made by fibers, fiber segments and other plastic particles washed out of clothing during washing. The fiber length of such washed-out microplastic particles is typically between about 100 μm and 800 μm. The fiber diameter is typically significantly smaller, about a factor of 30. Flaky textile components with edge lengths well below 1 mm are also released, which are also referred to as microplastics.

A fluid filter for filtering fibers out of washing machine waste water is known from the publication DE 10 2016 004 326 A1. The wastewater flows through an inlet opening into a filter housing in which a first filter screen is arranged. The wastewater flows through the first filter screen and the filtrate flows out of a cavity formed by the filter housing through an outlet opening. The textile fibers remain trapped in the first filter screen. However, the textile fibers are kept in suspension by an agitator in order to prevent clogging of the first filter screen. After the washing process, a concentrated textile fiber suspension can then be drained from the filter housing via a manually operated valve into a collecting container with a coffee filter. The textile fibers then remain as retentate like coffee grounds in a coffee filter and can be disposed of properly. The filtrate is discharged into the sewage system. The separated fibers, i.e. the retentate, are disposed with the second filter screen in the household waste.

US 2009/0071912 A1 also proposes a fluid filter for separating textile fibers from washing machine wastewater. The fluid filter consists of a filter drum with a coaxial inlet that rotates around a helix. The helix directs the fluid flow against the single filter screen so that it is rinsed free by the fluid flow. As the filter screen rotates relative to the helix, it acts like a screw conveyor and transports the separated textile fibers as retentate to the free end of the filter drum, which is opposite the inlet.

The subject matter of utility model DE 20 2019 003 578 U1 is a filter system for removing microfibers from the wastewater of a washing machine with a vertically extending drain pipe. A plurality of filter elements are arranged in series one behind the other in the drain pipe as viewed in the direction of flow of the waste water. There are maintenance openings in the side wall of the wastewater pipe which allow access to the filters.

### SUMMARY

The invention is based on the realization that the known technical methods for separating microplastics from washing machine waste water only work in theory, but are difficult to use on a day-to-day basis. As a result, the known methods are therefore not accepted or only poorly accepted by end users. The solutions of the related art are not yet suitable for integration into a machine, such as a washing machine.

Implementations of the invention solve the problem of providing a solution that enables simple handling when cleaning washing machine waste water or other fluids are to be cleaned.

Embodiments of the invention include a fluid filter, as well as a washing machine with the fluid filter and also a maintenance cover for the fluid filter or a washing machine with the fluid filter. In particular, the stated problem is solved by a combination of a filter screen and a brush as discussed below in more detail. 1. Preferred embodiments are the subject of the dependent claims.

The fluid filter has a filter housing, at least one first filter screen, and at least one second filter screen. The filter housing forms a cavity and includes at least one inlet opening and at least one outlet opening, through which a fluid can flow into the cavity or flow out again. Accordingly, the arrangement of the inlet opening and outlet opening defines a flow direction. In other words, the inlet opening and outlet opening define a flow direction from the inlet opening to the outlet opening.

The first filter screen may be arranged in the cavity, with the inlet opening and the outlet opening being in fluid communication through the first filter screen. In other words the inlet opening and the outlet opening are communicatingly/fluidly connected via the first filter screen. Communicatingly connected means that a fluid flow can flow from the inlet opening through the first filter screen to the outlet opening, whereby particles contained in the fluid are retained/separated by the first filter screen. The first filter screen at least partially delimits a first filter chamber. The first filter chamber may be on the inlet side of the first filter screen. The first filter chamber includes a retentate outlet and may be delimited on the outlet side by the first filter screen. Preferably, a second filter screen may also be arranged in the cavity of the filter housing, with the inlet and outlet also communicating with each other through the second filter screen. The second filter screen may therefore preferably be connected at least partially parallel to the first filter screen, whereby the term parallel here refers to the flow of the fluid (e.g. waste water). The retentate outlet of the first filter screen may preferably be arranged on the inlet side of the second filter screen. Consequently, fluid from the first filter chamber can also enter the second filter chamber through the retentate outlet; additionally or alternatively, the second filter chamber can have a separate fluid inlet. In terms of a flow diagram, the first filter screen and the second filter screen are therefore arranged in parallel (“connected”) for the fluid and in series (“connected”) for the retentate. The series connection results from the fact that retentate can at least enter the second filter chamber from the first filter chamber, if not by design, and retentate is prevented from leaving the second filter chamber by the second filter screen. Consequently, during operation of the fluid filter, the retentate that has been retained by the first filter screen is collected on the second filter screen. Manual cleaning of the first filter screen can be omitted. In addition, the first filter screen can preferably be cleaned automatically, which limits the upward flow resistance through the fluid filter. This reliably counteracts clogging of the fluid filter.

The preferred automatic cleaning can be carried out, for example, by a motor-driven brush whose bristles sweep over the first filter screen. This means that a free end of at least one bristle rests against the first filter screen, preferably on the inlet side, and/or the brush may be driven to move relative to the first filter screen, wherein the movement of the free end of the bristle being described by a trajectory that lies at least partially on the first filter screen.

Preferably, the fluid filter includes an agitator. Particularly preferably, the agitator includes at least one agitator shaft, which may be driven, preferably motor-driven. For example, an electric motor and/or a hydraulic motor driven by the flow of the waste water (and/or the water inlet) can serve as the drive of the agitator.

The bristles can be attached to the agitator. This allows the free ends of the bristles to sweep over the side of the first filter screen facing the first filter chamber when the agitator is moved. For this purpose, the agitator can have at least one bar. The bar or bars can be connected to the agitator shaft, for example. At least one bristle holder can be attached to at least one bar. In the case of a rotating agitator, for example, the bristle holder can preferably be attached to a radial end of the at least one web, with radial at this point referring to the axis of rotation of the agitator shaft. For example, the agitator can also be a bristle holder.

The bristles can be attached to the bristle holder on the side of the bristle holder facing the first filter screen. When the agitator shaft is set in rotation by a drive, e.g., an electric or hydraulic motor, the bristle holder(s) may be entrained over the bars and the bristles sweep over the side of the first filter screen facing the first filter chamber. This removes any retentate adhering to the filter screen. The retentate can, for example, contain microplastic particles, fibers and the like.

The retentate can be transported by the fluid flow from the inlet opening to the outlet opening and/or by the agitator. For example, the at least one bristle holder can be arranged in a spiral or spiral segment shape so that the agitator resembles a screw conveyor. Similarly, the webs or the at least one web or parts thereof can be designed as a helix or as helix segments. It could be said that at least one web may preferably be designed as a helix or helix segment and/or includes at least one helix and/or includes at least one helix segment. Just as the number of bristle holders is not limited, i.e. “a bristle holder” is to be understood in the sense of “at least one bristle holder”, the number of webs is not limited, i.e. preferably there may be at least one web to which preferably at least one bristle holder may be attached. At least three bristle holders are preferred, particularly in the case of rotating brushes, as a result of which an additional radial bearing can be omitted.

The filter housing preferably includes a maintenance opening that may be closed with a maintenance cover. The maintenance cover may preferably be easily detachable, i.e. the maintenance opening can be released accordingly. Any blockages or other problems with the fluid filter can be easily rectified through the maintenance opening.

Preferably, the second filter screen may be attached to the maintenance cover. Consequently, it may then be sufficient to open the maintenance cover at regular intervals, whereby the second filter screen may be removed from the housing. Preferably, the contour of the second filter screen may be smaller than the contour of the maintenance cover when viewed from above, so that the second filter screen can be easily removed. Other contours are also possible. When selecting the contour, however, it should preferably be taken into account that the second filter screen can preferably be removed through the maintenance opening. For example, toroidal segment-shaped filter screens are also possible. With the maintenance cover open, the second filter screen can then be cleaned and reused or, if necessary, replaced together with the maintenance cover and/or removed with the maintenance cover, cleaned and reused. Preferably, however, the second filter screen is only used once, as otherwise there is a risk that a user will wash out the screen and the retentate separated from the wash water will end up in the waste water system. To prevent a washed-out second filter screen from being reused, a machine-readable identification mark, e.g. an RFID chip, can be attached to it. A machine control system can then use the identification marking to recognize whether a previously removed second filter screen has been reinserted or whether a different (new) second filter screen has been used. If a previously removed second filter screen has been reinserted, the machine control system can prevent the machine from operating and/or display a warning message

The need to replace or clean the second filter screen can be symbolized or indicated, for example, by a display on a washing machine control unit. In the simplest variant, the second filter screen may be replaced or cleaned after a predefined number of washing cycles. Alternatively or additionally, the volume of retentate retained in the second filter screen can be measured and, if the measured value reaches a predetermined target value, the need to replace and/or clean the filter screen can be symbolized. Alternatively or additionally, if the limit value and/or a limit value above it is reached, a wash program can be ended automatically and/or the restart of a new wash program can be prevented by the control unit.

As already described above, it is particularly preferred if at least a part of the second filter screen at least partially delimits a second filter chamber. The second filter chamber includes a corresponding inlet opening that communicates with the retentate outlet of the first filter chamber, so that both retentate from the first filter chamber and unfiltered fluid can enter the second filter chamber. When passing through the second filter screen, the fluid becomes filtrate and the retentate is retained in the second filter chamber. In this sense, the second filter chamber may preferably be connected to the first filter chamber at least in a retentate-tight (possibly also fluid-tight) manner, whereby the connection may preferably be detachable. For example, a sealing ring can be arranged between a surface delimiting the retentate outlet and a surface delimiting the inlet opening, whereby the free space, i.e. the transition between the retentate outlet and the inlet opening, may of course be permeable for retentate from the first filter chamber and fluid to be filtered.

The term filter chamber refers to an area separated from the clean side of the cavity by the corresponding filter screen. Such filter chambers can, for example, be circular-cylindrical, hemispherical, polygonal, conical, wave-shaped or the like. Not all boundary surfaces of the first or second filter chamber are necessarily formed by the first or second filter screen. For example, a part of the housing wall can delimit a part of the first and/or filter chamber.

Particularly preferably, the fluid filter includes a closure for the inlet opening of the second filter chamber, whereby the closure can be moved or transitioned between an open position and a closed position. In the closed position, the closure closes the corresponding inlet opening and thus the second filter chamber at least retentate-tight, preferably even fluid-tight. In the open position, the inlet opening is, as the name suggests, open, i.e. a flow of retentate and fluid from the first filter chamber into the second filter chamber can take place, preferably unhindered. As is generally the case, movable in this case means any type of movement, i.e. rotation, translation or superpositions of rotation and translation. The term movable could also be used instead of movable. Once the closure has been moved to the closed position, the second filter screen can be removed from the housing without the risk of the retentate or part of it falling out of the second filter chamber. Handling is significantly simplified and functional reliability is increased. The closure can be regarded as a switching valve that closes or opens the inlet of the second filter chamber, whereby the switching valve is in the open position during operation of the fluid filter, preferably permanently in the open position. Before, during or by removing the second filter screen, the switching valve may then be closed, i.e. when the second filter screen is removed and/or when the maintenance cover is open, the closure is in the closed position.

Particularly preferably, in one specific embodiment the closure may be pretensioned in the direction of its closed position, at least when it is not in the closed position. This means that the closure automatically returns to its closed position, provided no external forces act on it. This can be achieved, for example, by tensioning a spring when the closure is opened, which loads the closure into its closed position. Instead of the elastic spring, another energy storage, preferably a potential energy storage, can also be used. The fluid filter preferably includes an opening device that holds the closure in its open position when the maintenance cover is closed or moves the closure from the closed position to the open position when the maintenance cover is closed. When the maintenance cover is subsequently opened, the opening device can preferably release the path of the closure into its closed position so that the inlet opening of the second filter chamber is reliably and automatically closed as soon as the maintenance cover is opened. This further simplifies handling when changing the second filter screen. In a particularly preferred example, the opening element is a connecting piece.

Equally preferred, as embodied in a related implementation, the fluid filter can have at least one movable compression means that can be configured to be moved from a neutral position to a compression position. In the compression position, the compression means can be configured to deform the second filter screen and thereby be configured to compress the second filter chamber. As a result, the retentate may be compressed and any remaining fluid from the second filter chamber may be pressed through the second filter screen. When removing the second filter screen, the risk of dripping is therefore significantly reduced if the movable compression means has been moved into the compression position at least once beforehand. If necessary, it can of course also be returned to the neutral position before removal. Alternatively or additionally, the compression means can separate at least one section of the second filter chamber from at least one other section of the second filter chamber in the compression position. This effectively reduces the size of the second filter chamber, which also leads to compression of the retentate, i.e. any fluid still stored in the retentate may be pressed through the second filter screen and the risk of dripping when removing the second filter screen is further reduced. For example, a slide can be moved through an inlet opening of the second filter screen along the filter screen into the second filter chamber, whereby retentate arranged in front of the slide in the direction of movement may be compressed and consequently dewatered. Preferably, the slide may be moved in the direction of a section of the second filter screen, whereby the retentate between the second filter screen and the corresponding section may be compressed.

Particularly preferably, the maintenance cover includes a locking mechanism that has a locking position and an unlocking position. In the locked position, the locking mechanism prevents or at least inhibits opening of the maintenance cover, e.g. by the locking mechanism or a part thereof engaging positively in a recess in the maintenance cover and/or the housing. Alternatively, the locking mechanism can also or additionally act non-positively on the maintenance cover so that the maintenance cover can be opened non-destructively, e.g. by applying a lever, if the locking mechanism malfunctions. The locking mechanism may preferably be in operative connection with the closure for the inlet opening and/or the compression means. Preferably, moving the closure into the closed position causes the locking mechanism to be unlocked and vice versa. In addition or alternatively, moving the compression means into the compression position and optionally back into the neutral position can unlock the locking mechanism. Preferably, the locking mechanism may be self-locking when the maintenance cover is closed. The locking mechanism may preferably be configured to ensure that the maintenance cover is only opened when the inlet opening is closed and/or after excess fluid has been pressed through the second filter screen. The risk of dripping when removing the second filter screen is further reduced.

An agitator may be particularly preferred at least in the first filter chamber. The agitator can be driven electrically and/or by the flow of the fluid. For example, the agitator can have at least one brush whose bristles brush over the first filter screen or at least parts of it, i.e. brush it off. As usual, the brush can have a bristle holder to which the bristles are attached. The bristles, or more precisely brushing over the first filter screen with the bristles, can prevent clogging of the first filter screen and at the same time promote reliable removal of the retentate through the retentate outlet into the second filter chamber. This ensures a uniform flow resistance of the fluid filter. Preferably, the bristles do not sweep over at least part of the second filter screen during operation, so that the retentate can accumulate there like a filter cake.

Preferably, the bristles have a fiber diameter d≤dₘₐₓ where dₘₐₓ is an element of the set {0.14 mm; 0.12 mm; 0.1 mm; 0.09 mm; 0.08 mm; 0.05 mm}, i.e. dₘₐₓ/mm ∈{0.14; 0.12; 0.1; 0.09; 0.08; 0.05}. In these cases, cleaning is particularly effective. The lower limit dₘᵢₙ for the fiber diameter of the bristles is 5 μm, i.e. dₘᵢₙ≥5 μm. To summarize, it would be preferred to have dₘᵢₙ≤d≤dₘₐₓ where dₘₐₓ/mm ∈{0.14; 0.12; 0.1; 0.09; 0.08; 0.05} and dₘᵢₙ≥5 Ξm. Plastic fibers with a corresponding fiber diameter can reliably clean microplastics from the first screen, with the fiber length preferably being between 14 mm and 2 mm. Particularly preferably between 10 mm and 4 mm. The first filter screen and the second filter screen preferably each have a mesh size of m₁, m₂. The lower limits of the two mesh sizes m₁, m₂ is preferably an element of the set U={20 μm, 30 μm, 40 μm, 45 μm, 50 μm} and the upper limit from the set O={50 μm, 55 μm, 60 μm, 70 μm, 80 μm, 90 μm, 100 μm} so that for the mesh size mᵢ applies u≤mᵢ≤o, u∈U, o∈O, i∈{1,2}. For example, mesh sizes between 20 μm and 80 μm are preferred. Mesh sizes between 30 μm and 70 μm are particularly preferred, and mesh sizes between 45 and 60 μm are especially preferred.

In addition, it has been observed in complex tests that the optimum fiber diameter correlates with the free length of the bristles. The preferred ratio is d/l of fiber diameter d of the bristles to the free fiber length l of the bristles is around 20 to 200, preferably in the range of 50 to 100, i.e. preferably

$$\frac{1}{20} \leq \frac{d}{l} \leq \frac{1}{200}$$

or particularly preferably

$$\frac{1}{50} \leq \frac{d}{l} \leq \frac{1}{100} .$$

A combination of a filter screen and a brush with one of the aforementioned properties can also be used in other filter applications, in particular also without the second filter screen described above. Of course, it is to be assumed that a free end of at least one bristle lies against the first filter screen, preferably on the inlet side, and/or the brush is driven movably relative to the first filter screen, the movement of the free end of the bristle being described by a trajectory which lies at least partially on the first filter screen.

The fluid filter described above can be integrated very easily into a washing machine, for example, or into any other machine with a machine housing, especially if the machine includes a fluid basin with a pump sump. Above the pump sump there may typically be a fluid drain connection, e.g. a water drain connection, e.g. for washing water. Preferably, the inlet opening of the fluid filter may be connected to the pump sump in a fluid-tight manner. The outlet opening of the fluid filter may preferably be connected to the suction side of the fluid pump in a fluid-tight manner. On the discharge side, the pump may preferably be connected to a drain connection, e.g. a wash water drain connection, via a waste water line. Alternatively, the pump can also be arranged between the pump sump and the inlet opening and connected accordingly to the pump sump and the inlet opening of the fluid filter.

The drain connection may typically be arranged above the pump sump and its height defines the maximum filling height of the machine. When the fluid filter is arranged between the pump sump and the suction side of the pump, it may be particularly preferable to have a reservoir between the fluid filter and the suction side of the pump, the volume of which at least corresponds to the volume of the waste water line. This prevents filtrate from flowing from the waste water line back into the fluid filter or the pump sump when the pump is switched off. When the maintenance cover is opened, no fluid escapes from the machine. The same effect can be achieved if at least one non-return valve is arranged on the outlet side of the first filter screen and/or the second filter screen, which only allows a flow from the clean side of the at least two filter screens to the suction side of the pump. Once the filtrate has been sucked out of the fluid filter housing, it cannot flow back into the cavity formed by the filter housing.

Alternatively or additionally, a non-return valve can be arranged on the inlet side of the first filter chamber and/or first filter screen, e.g. in the inlet opening or on the inlet side of the inlet opening. If a non-return valve is arranged on the inlet side of the first filter screen, it is preferable if at least one optional bristle sweeps over the valve seat and/or the valve tappet when the non-return valve is open, in order to avoid an accumulation of fibers on the sealing surfaces of the non-return valve. Like the optional bristles already mentioned above, these bristles can be arranged on the optional agitator, possibly on an optional bristle holder.

### BRIEF DESCRIPTION OF THE DRAWINGS

In the following, the invention will be described by way of example, without limitation of the general inventive concept, on examples of embodiment and with reference to the drawings.

FIG. 1 shows a first example of the fluid filter.

FIG. 2 shows a second example of the fluid filter.

FIG. 3 shows a third example of the fluid filter.

FIG. 4 shows a fourth example of the fluid filter.

FIG. 5 shows a maintenance cover for the fluid filter.

FIG. 6 shows a fourth example of the fluid filter.

FIG. 7 shows a maintenance hatch with a filter screen.

Generally, the drawings are not to scale. Like elements and components are referred to by like labels and numerals. For the simplicity of illustrations, not all elements and components depicted and labeled in one drawing are necessarily labels in another drawing even if these elements and components appear in such other drawing.

While various modifications and alternative forms, of implementation of the idea of the invention are within the scope of the invention, specific embodiments thereof are shown by way of example in the drawings and are described below in detail. It should be understood, however, that the drawings and related detailed description are not intended to limit the implementation of the idea of the invention to the particular form disclosed in this application, but on the contrary, the intention is to cover all modifications, equivalents and alternatives falling within the spirit and scope of the present invention as defined by the appended claims.

### DETAILED DESCRIPTION

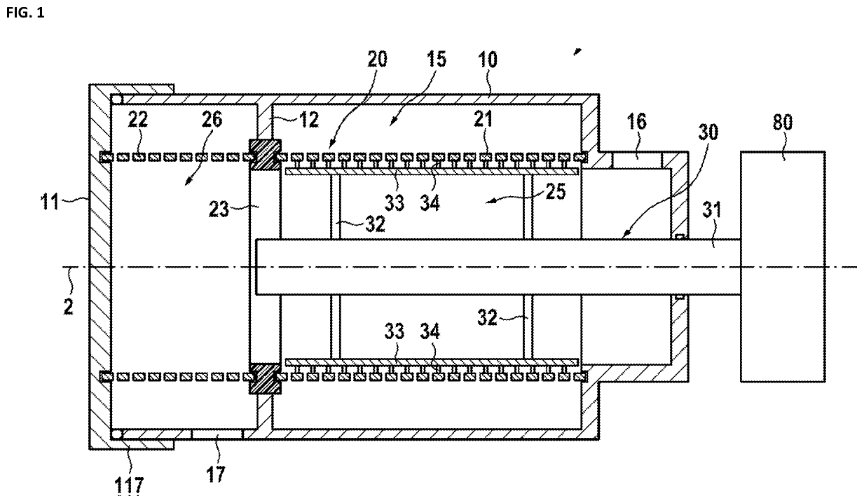

FIG. 1 shows a fluid filter 1 with a filter housing 10. The filter housing 10 includes a maintenance opening, which in FIG. 1 is closed by a maintenance cover 11. The closure may preferably be fluid-tight or configured to be substantially fluid impenetrable. This can be achieved, for example, by a seal, a labyrinth seal or the like clamped between the maintenance cover 11 and an edge of the filter housing 10 bounding the maintenance opening. Like in FIG. 1, the maintenance cover may be attached to the edge of the housing and fixed in place by a friction fit. Alternatively, however, other connection techniques can also be used, such as a threaded connection, bayonet lock, snap-in lock, swivel connection, . . . , i.e. all these examples can be replaced by any other, preferably detachable fastening technique.

The filter housing 10 may include an inlet opening 16 and an outlet opening 17. The inlet opening 16 can, for example, be connected via a line to a pump sump or the pressure side of a pump of a washing machine or another machine. The outlet opening 17 can, for example, be connected to the suction side of a pump for pumping out a fluid. Both, the inlet opening 16 and the outlet opening 17 allow access to a cavity 15 enclosed by the filter housing 10. A first filter screen 21 and a second filter screen 22 are preferably arranged in the cavity 15 of the filter housing. The first filter screen 21 may delimit a first filter chamber 25, which communicates with the inlet opening 16. As in the example shown, the first filter screen 21 may be barrel-shaped and the first filter chamber 25 may correspondingly be at least approximately a circular cylinder with a longitudinal axis 2. However, other geometries of the first filter chamber are also possible. In order to keep the figure clearer, only the cut surface of the filter screens 21, 22 is shown (applies to all figures); the interior view of the two filter screens actually shown in the sectional drawings has been omitted, because the other details would hardly be recognizable against the grid background.

On the side facing away from the inlet opening 16, the first filter chamber 25 may include a retentate outlet. Like in the example shown, the retentate outlet may be the passage opening of a sealing ring 23, which may at the same time form the inlet opening of a second filter chamber 26. The second filter chamber 26 may be bounded by the second filter screen 22, similar to the way in which the first filter chamber 25 may be bounded by the first filter screen 21. The first filter screen 21 and the second filter screen 22 may be connected by a seal 23 (e.g. by said sealing ring 23) to form a filter element 20. A wall, e.g. that of the housing cover 11, preferably delimits the second filter chamber 26 on the side opposite the inlet opening 23 of the second filter chamber 26. Alternatively, the second filter chamber 26 can also be delimited by a separate base and/or the second filter screen 22 instead of the wall. The second filter screen can, for example, form a filter basket.

Preferably, the fluid filter 1 includes an agitator 30. Particularly preferably, the agitator 30 includes an agitator shaft 31, to which bristles 34 may be attached. The free ends of the bristles 34 may sweep over the side of the first filter screen 21 facing the first filter chamber 25 when the agitator 30 moves. For this purpose, the agitator can, for example, have webs 32, to the radial end of which at least one bristle holder 33 may be attached. The bristles 34 may be attached to the bristle holder 33 on the side of the bristle holder 33 facing the first filter screen 21. If the agitator shaft 31 may set in rotation by an optional drive 80, then the bristle holders 33 may be entrained via the webs 32, so that the bristles 34 sweep over the side of the first filter screen 21 facing the first filter chamber and thereby clean off retentate adhering to the first filter screen 21, e.g. microplastic particles. As in the example shown, the bristles 34 preferably do not sweep over the second filter screen 22, or at least not completely. As a result, during operation of the fluid filter 1, retentate accumulates in the second filter chamber on the side of the second filter screen 22 facing the second filter chamber 26.

The retentate can be transported on the one hand by the fluid flow from the inlet opening 16 to the outlet opening 17 and/or by the agitator 30. For example, the bristle holders 33 can be arranged in a spiral or spiral segment shape, so that the agitator resembles a screw conveyor. At this point, it should be noted that two bristle holders 33 are shown in the drawing, but that this number is merely exemplary and is to be understood in the sense of “at least one bristle holder”.

During operation, a fluid to be filtered, e.g. washing water to be filtered from a washing machine or another machine, may be fed into the first filter chamber 25 via the inlet opening 16 and also into the second filter chamber 26 through the retentate outlet opening. Part of the fluid flows through the first filter screen 21 and the second filter screen 22 and may be drawn off at the outlet opening 17. Impurities carried along by the fluid may be retained by and may hence remain on both the first filter screen 21 and the second filter screen 22.

The impurities deposited on the first filter screen 21 are cleaned off by the bristles 34 of the agitator 30, so that the first filter screen 21 is kept free. Retentate cleaned by the bristles 34 passes through the flow and preferably through the agitator 30 into the second filter chamber 26, where it may again be separated, but this time on the second filter screen 22. The cleaned fluid, i.e. the filtrate, can leave the fluid filter 1 through the outlet opening 17. Preferably, before the second filter chamber 26 is completely filled with retentate, the fluid flow through the inlet may preferably be stopped at least briefly, with any remaining fluid residues preferably being drawn off through the outlet opening 17. The maintenance cover 11 can now be opened and the retentate can be removed from the second filter chamber. In a preferred embodiment, as shown, the second filter screen may be firmly connected to the maintenance cover 11, so that when the maintenance cover is opened, retentate collected in the second filter chamber 26 can be removed together with the second filter screen. This unit can then be disposed of in accordance with local regulations and replaced by a new maintenance cover 11 with filter screen 22 attached to it.

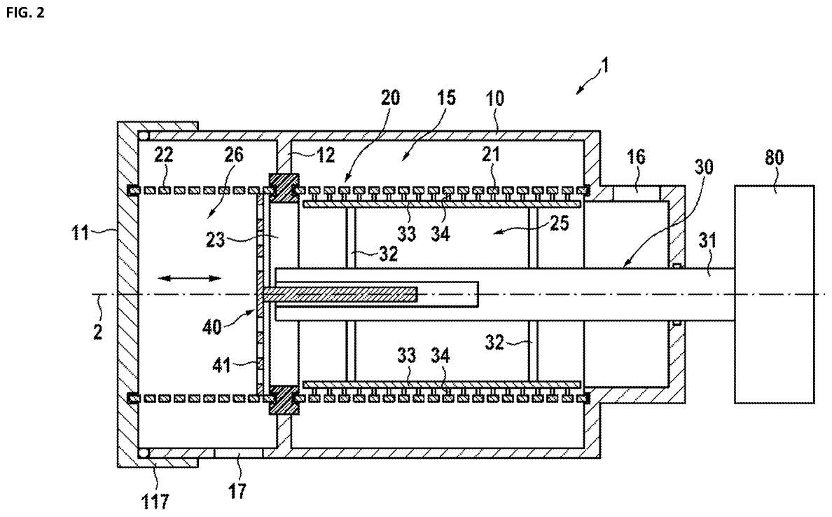

FIG. 2 shows a further fluid filter 1 which is largely similar to the fluid filter 1 according to FIG. 1, so that the description of FIG. 1 can be read in its entirety to FIG. 2. In addition, the fluid filter 1 in FIG. 2 includes an optional compression means 40 with which retentate accumulated in the second filter chamber 26 can be compressed. As a result, on the one hand, the maintenance intervals of the fluid filter can be extended and, on the other hand, the retentate in the second filter chamber 26 can be compressed with the compression means 40, so that fluid still contained therein drains through the filter element 20, whereby undesired dripping of fluid from the maintenance cover 11 or from the second filter chamber 26 can be prevented or at least reduced. The compression means 40 preferably includes a grid 41 which, as indicated by the double arrow, can be moved parallel to the wall of the second filter screen. As in the example shown, the grid may be located at the free end of a piston rod of the agitator 30. It should also be mentioned that the mesh width of the grid 41 may be larger than the screen width of the filter element 20, so that cleaned retentate can be transferred through the meshes of the grid 41 into the second filter chamber 26.

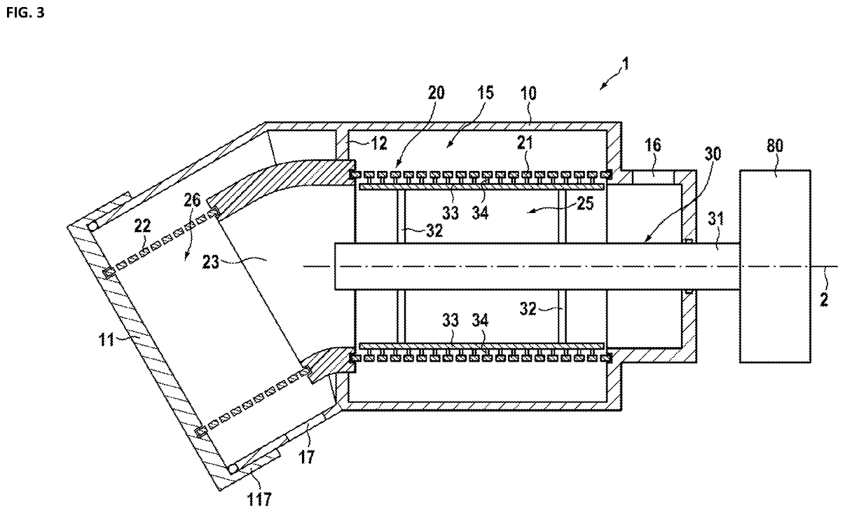

FIG. 3 shows another fluid filter 1 and the description of FIG. 1 can again be read (almost) in full for the fluid filter 1 in FIG. 3. Only the differences are explained to avoid repetition. The fluid filter in FIG. 3 differs from the fluid filter in FIG. 1 only in that the first filter chamber and the second filter chamber are not arranged coaxially, but at an angle to each other. As a result, the retentate collects at the bottom of the second filter chamber 26, at least also due to gravity.

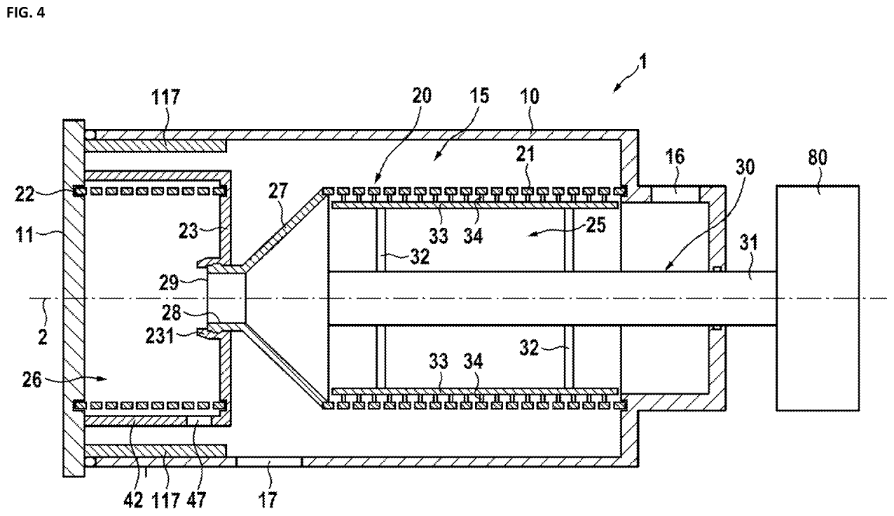

FIG. 4 shows a further fluid filter in longitudinal section along the longitudinal axis 2. The description of FIG. 1 can also be read (almost) completely onto FIG. 4, so that only the differences between the two fluid filters 1 are discussed below. In FIG. 4, the first filter screen 21 tapers on the side facing away from the inlet opening 16 in a section 27 referred to as taper 27 to form a nozzle, the open end of which forms the retentate outlet 29. The connecting piece 28 with the retentate outlet may project into the second filter chamber 26 through a seal 23 which may lie at least largely sealingly against the outside of the connecting piece 28. The seal 23 may delimit the second filter chamber 26 on the inlet side. The seal 23 can (other than shown) be attached to the second filter screen 22, for example. Like in the example shown, the seal 23 may be attached to the maintenance cover 11. For example, the seal 23 can be a sealing membrane that may be attached to an inlet-side section of an optional annular web 42. Inlet side here refers to the inlet of the second filter chamber 26, wherein the inlet is the opening of the second filter chamber 26 facing the inlet 16 of the filter housing 10 (with respect to the flow direction). As in the example shown, the seal 23 may span the second filter chamber on the inlet side. At least the optional section of the seal 23 between the second filter screen 22 and the optional annular web 42 of the maintenance cover 11 can be designed as a rigid wall. At least the section of the seal 23 through which the connecting piece 28 protrudes or in which it engages may preferably be made of an elastic material, e.g. a rubber-elastic material.

The optional annular web 42 can, for example, enclose the second filter screen and the second filter chamber 26 together with the base of the maintenance cover 11, as shown in FIG. 4. In order to improve the drainage of the filtrate, the annular web 42 can preferably have at least one drip opening 47 in its area facing the inlet.

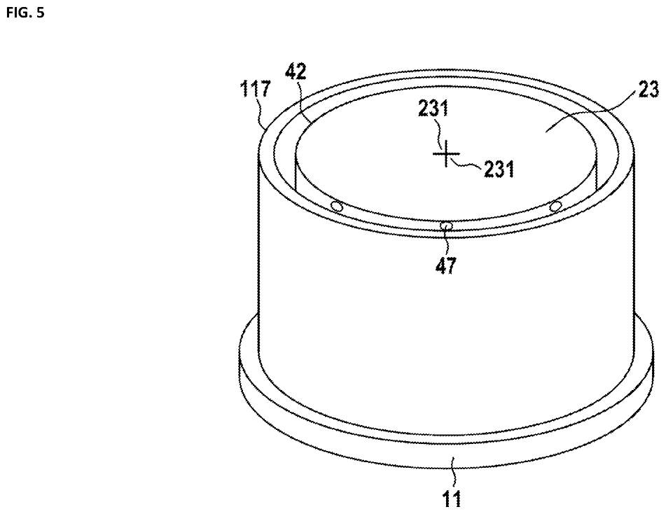

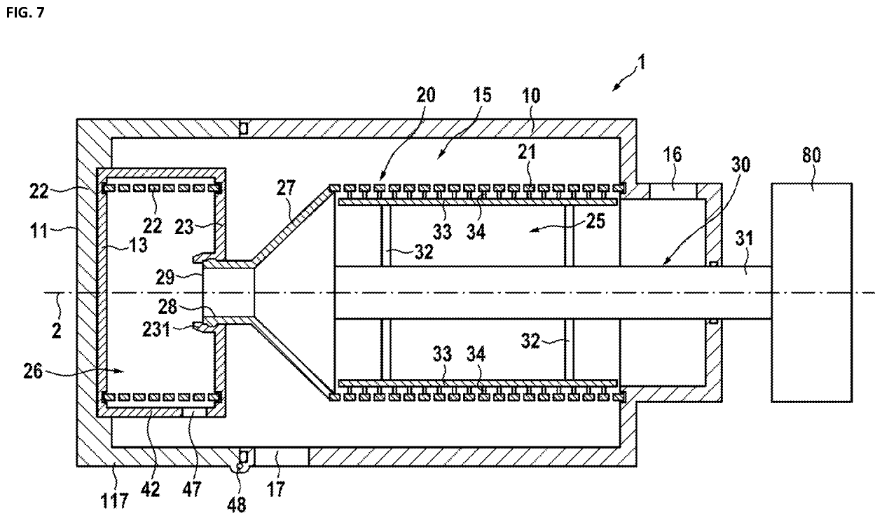

If the maintenance cover in FIG. 4 is removed, the base of the maintenance cover 11 with its annular web 42 may form a basin that prevents unwanted dripping of residual fluid from the second filter chamber. Any filtrate escaping from optional drip openings 47 can, for example, be retained by an optional edge web 117 (see FIG. 5), which can, for example, have a thread or a joint 48 (see, for example, FIG. 7) for connecting the maintenance cover 11 to a base body of the filter housing 10.

Optional elastic flaps 231 on the seal 23 can, as shown in FIGS. 5 to 7, at least largely close the inlet to the second filter chamber, i.e. they may form a closure 231 of the inlet to the second filter chamber, which greatly simplifies a clean replacement of the second filter screen. When the second filter screen 22 is inserted into the housing, the connecting piece 28 acts as an opening device for the closed inlet of the second filter chamber 26. In addition, the optional flaps 231 can prevent improper emptying of the filter, for example by washing it out. The elastic flaps 231 serve here as an example of a closure of the inlet opening that may preferably be biased into its closed position, similar to a duckbill valve. Alternatively, the closure can be designed as a duckbill valve. As a further alternative, the closure can have at least one closure flap or the like, e.g. hinged, which may preferably be movable into the second filter chamber. Particularly preferably, the closure flap may be biased in the direction of its closed position when in the open position.

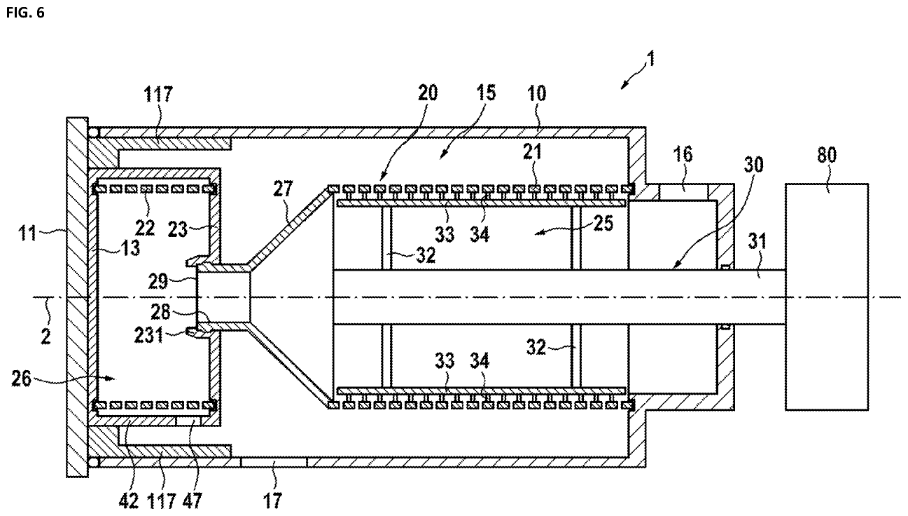

As shown in FIG. 6, the second filter screen 22 can also be detachably connected to the maintenance cover 11, so that correspondingly less waste is produced. For this purpose, the second filter chamber may be delimited by a base 13, which can be inserted into a receptacle in the maintenance cover 13. A snap-in connection between the base 13 and the maintenance cover 11 may be preferred, but other fastenings are also possible, such as bayonet, screw thread, etc. p. The optional base 13 can also be part of the second filter screen 22. The optional base 13 can also be provided in the embodiments of FIGS. 1 to 5. Incidentally, the description of FIGS. 4 and 5 can also be read with reference to FIG. 6.

FIG. 7 is largely identical to FIG. 6 and differs only in that the maintenance cover 11 is not fastened to the base body with a screw connection, but with a joint 48. Incidentally, the description of FIG. 6 can also be read onto FIG. 7.

It will be appreciated to those skilled in the art having the benefit of this disclosure that this invention is believed to provide a fluid filter. Further modifications and alternative embodiments of various aspects of the invention will be apparent to those skilled in the art in view of this description. Accordingly, this description is to be construed as illustrative only and is provided for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

### LIST OF REFERENCE NUMERALS

1 fluid filter
2 longitudinal axis
10 filter housing
11 housing cover/maintenance flap/maintenance cover
117 edge web
12 housing web
13 base/floor
15 cavity
16 inlet opening/inlet
17 outlet opening/outlet
20 filter insert
21 first filter screen
22 second filter screen
23 seal/inlet opening of second filter chamber
231 closure/elastic flaps
25 first filter chamber
26 second filter chamber
27 tapered section/taper
28 connecting piece/opening device
29 retentate outlet
30 agitator
31 shaft
32 webs
33 brush holder
34 bristles
40 compression means
41 grid
42 ring/ring shaped web
47 drip opening
48 Joint
80 drive/motor

1. A fluid filter comprising: with a filter housing, a first filter screen, a second filter screen, an inlet opening, and an outlet opening, wherein:
the filter housing encloses a cavity and has at least the inlet opening and the outlet opening,
the first filter screen is arranged in the cavity,
the first filter screen at least partially delimits a first filter chamber and the second filter screen at least partially delimits a second filter chamber,
the inlet outlet openings communicate with each other through the first filter screen such that a fluid can flow from the inlet opening through the first filter screen to the outlet opening, thereby defining a direction of the fluid flow,
the first filter chamber has a retentate outlet,
the second filter screen is arranged in the cavity of the filter housing, the inlet outlet openings communicate with one another through the second filter screen and the retentate outlet is arranged on a side of the second filter screen that faces the fluid flow.

2. A fluid filter according to claim 1, wherein the filter housing has a maintenance opening that is closed with a maintenance cover, and wherein the second filter screen is fastened to the maintenance cover.

3. A fluid filter according to claim 1, wherein the first filter screen and the second filter screen are arranged parallel with respect to the direction of the fluid flow.

4. A fluid filter according to claim 1, wherein the first filter chamber and the second filter chamber are arranged in series with respect to a retentate flow.

5. A fluid filter according to claim 1, wherein at least a part of the second filter screen at least partially delimits a second filter chamber, wherein the second filter chamber has a corresponding second filter chamber inlet opening which is attached to a retentate outlet, whereby a retentate passage is formed from the first filter chamber into the second filter chamber.

6. A fluid filter according to claim 5, wherein the fluid filter comprises a closure for the second filter chamber inlet opening, the closure is movable between an open position and a closed position, the closure in the closed position closing at least a section of the second filter chamber at least in a retentate-tight manner.

7. A fluid filter according to claim 6, wherein
the closure is biased into the closed position,
when the maintenance cover is closed, the closure is transitioned into the open position by a connecting piece of the fluid filter,
when the maintenance cover is opened, the connecting piece releases the path of the closure to transition the closure into the closed position.

8. A fluid filter according to claim 1, wherein the fluid filter has at least one movable compression means configured to be moveable from a neutral position into a compression position, the compression means deforming the second filter screen in the compression position and thereby compressing the second filter chamber and/or separating at least one section of the second filter chamber from at least one other section of the second filter chamber.

9. A fluid filter according to claim 6,
wherein the fluid filter has at least one movable compression means configured to be moveable from a neutral position into a compression position, the compression means deforming the second filter screen in the compression position and thereby compressing the second filter chamber and/or separating at least one section of the second filter chamber from at least one other section of the second filter chamber,
wherein the maintenance cover has a locking mechanism which at least inhibits opening of the maintenance cover, wherein the locking mechanism is in operative connection with the closure for the second filter chamber inlet opening and/or the compression means, and wherein a movement of the closure into the closed position and/or a movement of the compression means into the compression position releases the locking mechanism.

10. A fluid filter according to claim 1, further comprising an agitator mounted movably relative to the first filter screen.

11. A fluid filter according to claim 10, further comprising bristles attached to the agitator to point in a direction of the first filter screen, wherein at least some of the bristles bear against the first filter screen, and wherein paths of movements of the bristles are defined by trajectories.

12. A fluid filter according to claim 11, wherein at least a part of a fluid flow facing side of the second filter screen is arranged outside the trajectories of the bristles.

13. A fluid filter according to claim 11, wherein the bristles are made of plastic and have a fiber diameter d smaller than or equal to dₘₐₓ, wherein dₘₐₓ/mm∈{0.14; 0.12; 0.1, 0.09; 0.08; 0.05}, and wherein d≥5 μm.

14. A fluid filter according to claim 1, wherein the first filter screen and/or the second filter screen comprises at least one mesh with a mesh width m₁ or m₂ wherein u≤mᵢ≤o and u∈U={20 μm, 30 μm, 40 μm, 45 μm, 50 μm} and o∈O={50 μm, 55 μm, 60 μm, 70 μm, 80 μm, 90 μm, 100 μm} and i∈{1, 2}.

15. A fluid filter according to claim 1, housed in a washing machine housing of a washing machine, wherein the washing machine housing comprises at least one washing water drain connection, at least one fluid basin with a pump sump and at least one pump.

16. A fluid filter according to claim 15, wherein Washing machine
the inlet opening is connected to the pump sump in a fluid-tight manner, and/or
the outlet opening is connected to a suction side of the pump in a fluid-tight manner, and/or
the pump is connected fluid-tight to a waste water pipe on a discharge side of the pump, and/or
the waste water pipe has an end facing away from the pump, said end forming a wash water drain connection, and/or
the wash water drain connection is located above the pump sump.

17. A fluid filter according to claim 16, wherein
there is a reservoir located between the fluid filter and the suction side of the pump, a reservoir volume corresponding at least to the volume of the waste water pipe, and/or
there is at least one non-return valve connected to an outlet side of the first filter screen and/or the second filter screen, said at least one non-return valve configured to only allow a flow from the outlet side of the first filter screen and/or the second filter screen to the suction side of the pump.

18. A maintenance cover for a fluid filter according to claim 2, wherein:
the maintenance cover includes the second filter screen, wherein at least a section of the second filter screen forms at least a section of the first filter chamber with the inlet opening;
at least one fluid-tight wall is located at a distance from the second filter screen such as to surround the second filter screen with the inlet opening of the second filter screen remaining free;
a closure of an opening of the second filter chamber is configured to be moveable between a closed position and an open position such as to close at least the inlet opening of the second filter screen in at least retentate-tight fashion in the closed position.

19. A maintenance cover according to claim 18, wherein the following conditions are satisfied:
wherein there is a gap between at least one section of the wall and at least one section of the first filter screen, said wall having a corresponding outlet opening,
further comprising an outlet valve affixed to the at least one fluid-tight wall, the outlet valve containing a valve means that is movable between a corresponding open position and a corresponding closed position,
wherein the valve means is preloaded into said corresponding closed position,
wherein the valve means has an abutment or is connected to said abutment, wherein the abutment is configured such that a force applied to the abutment moves the valve means from the corresponding closed position to the corresponding open position.

20. A combination of a first filter screen according to claim 1 and at least one brush with bristles configured to clean said first filter screen, wherein
the bristles are made of plastic and have a fiber diameter d smaller than or equal to dₘₐₓ, wherein dₘₐₓ/mm∈{0.14; 0.12; 0.1, 0.09; 0.08; 0.05} and wherein d≥5 μm, and/or
the first filter screen comprises at least one filter mesh with a mesh size m₁, wherein u≤m₁o, u∈U, o∈O and U={20 μm, 30 μm, 40 μm, 45 μm, 50 μm} and O={50 μm, 55 μm, 60 μm, 70 μm, 80 μm, 90 μm, 100 μm}, and/or
the bristles have a free fiber length/such that a ratio d/l of the fiber diameter d of the bristles to the free fiber length I of the bristles is about
$$\frac{1}{20} to \frac{1}{200} .$$

21. A combination according to claim 20, wherein the combination is a part of a fluid filter according to claim 1.
